(19) United States
(12) Patent Application Publication
(10) Pub. No.: US 2014/0160114 A1
(43) Pub. Date: Jun. 12, 2014

(54) Transformation of a Three-Dimensional Flow Image

(71) Applicant: Isis Innovation Limited, Oxford (GB)

(72) Inventors: Gordon Stevenson, Oxford (GB); Sally Collins, Oxford (GB); Julia Alison Noble, Oxford (GB)

(73) Assignee: Isis Innovation Limited, Oxford (GB)

(21) Appl. No.: 13/955,603

(22) Filed: Jul. 31, 2013

Related U.S. Application Data
(63) Continuation of application No. PCT/GB2012/000077, filed on Jan. 25, 2012.

(30) Foreign Application Priority Data
Feb. 2, 2011 (GB) 1101833.0

(51) Int. Cl. G06T 15/00

(52) U.S. Cl. CPC G06T 15/00
USPC 345/419

(57) ABSTRACT

A method of transforming a three-dimensional ultrasound Doppler image that represents flow within a subject uses a three-dimensional ultrasound intensity image that has a common field of view and represents structure within the subject. Within the three-dimensional structural image, there is identified a three-dimensional reference surface that represents the location of a surface of the structure represented by the three-dimensional structural image. A mapping is derived that maps the three-dimensional surface into a two-dimensional plane. The mapping is applied to map the three-dimensional surface of the flow image at the location represented by the three dimensional reference surface into a two-dimensional flow image.

### CROSS-REFERENCES TO RELATED APPLICATIONS

This application is a continuation of International Application No. PCT/GB2012/000077, filed Jan. 25, 2012, which is incorporated by reference in its entirety for all purposes.

### BACKGROUND OF THE INVENTION

The present invention relates generally to imaging that provides a three-dimensional flow image that represents flow within a subject under investigation, and in particular to processing of a three-dimensional flow image.

There are known imaging techniques that provide a three-dimensional flow image that represents flow within a subject under investigation, for example Doppler ultrasonography in which ultrasound Doppler signals are measured to provide an ultrasound Doppler image. Flow is of interest in many subjects. For example, in a biomedical study, a subject that is part of a human may be imaged to study flow, typically of blood, that provides information of clinical interest. However, in many applications, the visualisation and understanding of the flow is complicated and from the resultant three-dimensional flow images it can be difficult to extract useful information, for example clinically significant information in the case of a biomedical study.

By way of example, Doppler ultrasonography may be applied to image a placenta and uterus of a pregnant woman for investigating the blood flow therewithin during pregnancy. Based on two-dimensional studies as well as work in histopathology, these blood flows are thought to be indicative of how the pregnancy is progressing. To accommodate the demands of a growing fetus, the blood supply to the uterus needs to substantially increase during pregnancy. This requires physiological remodelling of the maternal spiral arteries from their usual narrow-bore, contorted form to low resistance, high capacity vessels. Histopathological studies have indicated that this remodelling process relies on the invasion of cells from the developing placenta into these maternal vessels. In pregnancy resulting in pre-eclampsia or fetal growth restriction, this invasion is thought to be sub-optimal resulting in vascular differences at the utero/placental interface. This is an area of high clinical activity currently and the tool provides a much needed way to advance both clinical understanding as well as has potential clinical value as a intra uterine growth restriction (IUGR) & pre-eclampsia screening tool in the future.

Prior work into investigating this pathology has considered the use of 3D power Doppler (PD) ultrasound to image the placenta or decidua/myometrium (maternal uterus closest to the placenta) and to take a somewhat arbitrary, “virtual biopsy” measurement by extracting a small region of interest (ROI), such as a sphere or cube, within the placenta (as disclosed in Reference 1—all references are cited at the end of this specification and are incorporated herein by reference) or to consider a manual segmentation that encompasses the whole organ (as disclosed in Reference 2). Besides being time consuming, both these approaches have their drawbacks as neither approach is a direct measurement of the site of the pathology. A “virtual biopsy” as disclosed in Reference 1 is only a representation of the organ's overall performance which itself has been shown histopathologically to be non-uniform. A manual segmentation as disclosed in Reference 2 is problematic in that quantification of a 3D ultrasound Doppler signal in the placenta and uterus is difficult because the organ is unique in having two independent vascular systems, that is one from the mother and the other from the fetus. These vascular systems have different compositions of red blood cells (that act as the scatterers of ultrasound) at different concentrations. Doppler ultrasonography estimates blood motion from scatterers movement and so assuming homogeneity across these two systems is incorrect. Thus, with both of the approaches, it is difficult to extract clinically significant information.

Similar difficulties of extracting useful information exist in the use of types of three-dimensional flow image other than an ultrasound Doppler image.

Information related to attempts to address these problems can be found in the following references, for example: Reference 1: Dar et al., “First-trimester 3-dimensional power Doppler of the uteroplacental circulation space: a potential screening method for preeclampsia,” American Journal of Obstetrics and Gynecology, 2010; Reference 2: de Paula et al., “Quantitative analysis of placental vasculature by three-dimensional power Doppler ultrasonography in normal pregnancies from 12 to 40 weeks of gestation,” Placenta, vol. 30, no. 2, pp. 142-148, 2009; Reference 3: Rohling et al., “3-D spatial compounding of ultrasound images”, Medical Image Analysis, Oxford University Press, Oxford, UK, 1(3), pp. 177-193, 1997; Reference 4: Xiao et al., “Non-rigid registration of 3D free-hand ultrasound images of the breast”, IEEE Transactions on Medical Imaging 21(4), p. 404-412, 2002; Reference 5: Grady, “Random walks for image segmentation,” IEEE Transactions on Pattern Analysis and Machine Intelligence, pp. 1768-1783, 2006; Reference 6: Maurer Jr. et al., “A linear time algorithm for computing exact Euclidean distance transforms of binary images in arbitrary dimensions,” IEEE Transactions on Pattern Analysis and Machine Intelligence, pp. 265-270, 2003; Reference 7: Sheffer et al., “Mesh parameterization methods and their applications,” Foundations and Trends in Computer Graphics and Vision, vol. 2, no. 2, pp. 105-171, 2006; Reference 8: Gelas et al., “Parameterization of discrete surfaces,” Insight Journal (Online), vol. 9, 2007: Reference 9: Yoo et al., “Engineering and algorithm design for an image processing api: a technical report on itk—the insight toolkit,” Studies in health technology and informatics, pp. 586-592, 2002; and Reference 10: Collins et al., “Direct measurement of blood flow into the intervillous space and its relationship with uterine artery blood flow,” Ultrasound in Obstetrics and Gynecology, vol. 36, no. S1, pp. 34, 2010. Various transformations, including some embodiments of the invention, can mitigate or reduce the effect of, or even take advantage of, some or all of these potential problems.

### BRIEF SUMMARY OF THE INVENTION

Certain embodiments of the invention aim to improve on the extraction of useful information from a three-dimensional flow image that represents flow within a subject under investigation.

In accord with a first embodiment, there is provided a method of transforming a three-dimensional flow image that represents flow within a subject, wherein the method additionally uses a three-dimensional structural image that has a common field of view with the three-dimensional flow image and that represents structure within the subject, and the method comprises:

identifying from the three-dimensional structural image a three-dimensional reference surface that represents the location of a surface of the structure represented by the three-dimensional structural image;

deriving a mapping that maps the three-dimensional reference surface into a two-dimensional plane; and

generating a two-dimensional flow image by applying the mapping to map a surface of the three-dimensional flow image at the location represented by the three-dimensional reference surface into the two-dimensional flow image.

The method uses a three-dimensional structural image that represents structure within the subject to assist in analysis of the three-dimensional flow image. The three-dimensional structural image has a common field of view with the three-dimensional flow image and so the two images represent two different types of information, flow and structure, of the same subject.

The three-dimensional structural image is used to identify a three-dimensional reference surface that represents the location of a surface of the represented structure. This is selected to be a surface at which the flow is of interest, and a surface of the three-dimensional flow image at the location represented by the three-dimensional reference surface may be extracted, and studied by display and visual investigation and/or quantitative analysis. However, it remains difficult to understand the flow represented by the data of this surface of the three-dimensional flow image in a meaningful way because it has a three-dimensional shape that in general may be irregular, creating difficulties in both understanding and quantification of the data. Furthermore, visual investigation is in general difficult, because in any given displayed view, parts of the surface are obscured due to the three-dimensional shape surrounding it.

This problem is reduced by flattening the surface of the three-dimensional flow image into a two-dimensional flow image. Such flattening is achieved by deriving a mapping that maps the three-dimensional reference surface into a two-dimensional plane, for example using mesh parameterisation. The mapping is then applied to generate a two-dimensional flow image by mapping a surface of the three-dimensional flow image at the location represented by the three-dimensional reference surface into the two-dimensional flow image. Thus, the two-dimensional flow image is generated by a transformation from the three-dimensional flow image. This two-dimensional flow image is easier to understand, and to extract information from, than the three-dimensional surface from which it is mapped. Irrespective of the shape of the three-dimensional reference surface, there results a two-dimensional flow image of a consistent shape, and so study is simplified, whether by display and visual investigation or quantitative analysis. This provides for consistency of analysis between different three-dimensional flow images of related subjects (e.g. the same subject at different times or different instances of a given type of subject), irrespective of differences in structure. Furthermore, the two-dimensional nature of the resultant image makes it straightforward to view without parts of the surface being obscured. That makes it easier for a viewer to investigate information of interest.

The method may be applied to a three-dimensional flow image that is an ultrasound Doppler image. This is a type of image that represents flow in a manner that is useful in many types of application, in particular in biomedical and clinical studies. However, the method may equally be applied to any other type of three-dimensional flow image that represents flow, for example blood oxygenation level dependent (BOLD) imaging or other types of functional magnetic resource imaging (fMRI).

The method may be applied to a three-dimensional structural image that is an ultrasound intensity image. This particularly advantageous when the three-dimensional flow image is an ultrasound Doppler image, because in that case both three-dimensional images may be acquired using a common ultrasonography apparatus, simply by differently processing the measured signals. However, the method may equally be applied to any other type of three-dimensional structural image that represents structure, for example a magnetic resonance imaging (MRI) image or Computed Tomography (CT) image.

The three-dimensional reference surface may represent the location of a boundary of a part of the structure or an interface between two parts of the structure. In this case, the two-dimensional flow image represents the flow at that boundary or interface. This may be useful in many types of study where the flow at a boundary or interface is of interest, as is commonly the case.

The method may be applied to a subject that is a biological subject, for example a part of a human body. This may be useful to provide information of clinical significance, for example for use by a medical practitioner.

The method has particular application to study a subject that is a placenta and uterus of a pregnant woman. This allows investigation of the blood flow at this interface which may provide clinically useful information about the progression of the pregnancy. In this case, the three-dimensional reference surface may be an interface between the placenta and the uterus. This allows study of the vasculature of the developing placenta. Referencing the study to this interface has particular clinical utility, because this interface is the site of vascular pathology that leads to major maternal and fetal morbidity and to many fetuses being born small for gestational age based on their genetic potential. This is due to the arterioles that feed the placenta not being adequately converted into larger, less resistive vessels. As compared to a “virtual biopsy” as disclosed in Reference 1 this method allows study of the entire interface, rather than study of just the site of the “virtual biopsy” which loses information encapsulated by the whole surface. As compared to a manual segmentation as disclosed in Reference 2, selection of this interface rather than the whole organ improves the clinical utility because the interface separates the two independent vascular systems in the placenta and the uterus.

Advantageously, the method further comprises:

identifying from the three-dimensional structural image offset three-dimensional reference surfaces that represent locations separated at respective distances from the location represented by the first mentioned three-dimensional reference surface; and

performing said steps of deriving a mapping and generating a two-dimensional flow image in respect of each of the offset three-dimensional reference surfaces, as well as the first mentioned three-dimensional reference surface.

Thus, as well as generating a two-dimensional flow image representing the flow at the location of the first mentioned three-dimensional reference surface, the method generates further two-dimensional flow images representing the flow at offset three-dimensional surfaces separated at respective distances therefrom. This provides a stack of two-dimensional flow images representing flow at discrete distances inwardly and/or outwardly from the initial reference surface. This allows investigation of the flow at a stack of reference surfaces that are consistent with the initial reference surface. The advantages described above of mapping the surface of the three-dimensional flow image at the location represented by the first mentioned three-dimensional reference surface into a two-dimensional flow image (that is in assisting understanding and extraction of information and of assisting visual study by preventing parts of the surface from being obscured) apply equally to the entire stack of two-dimensional flow images as to the first two-dimensional flow image.

In the example of application of the method to a placenta and uterus of a pregnant woman, this allows study of either or both of the two independent vascular systems in the placenta and the uterus, across the interface. For example, a stack of two-dimensional flow images may be derived and displayed to illustrate the vasculature from the uterus on the maternal side, across the interface and into the placenta. This is achieved by selection of the three-dimensional reference image as the interface between the placenta and uterus, which provide a clinically useful analysis of the haemodynamics of the flow within the utero-placental unit. Poor remodelling is hypothesised to lead to differences in flow throughout the vasculature so investigating these surfaces may glean further knowledge into blood flow both over gestation and in the normal and pathological case.

### BRIEF DESCRIPTION OF THE DRAWINGS

To allow better understanding, an embodiment of the present invention will now be described by way of non-limitative example with reference to the accompanying drawings, in which:

FIG. 1 is a flow chart of a method of transforming a 3D flow image;

FIG. 2 is a flow chart of a method of identifying a boundary or interface in a 3D structural image;

FIG. 3 is a 2D slice of a 3D ultrasound intensity image of a placenta and uterus of a pregnant woman;

FIG. 4 is a diagram illustrating a mapping between a 3D mesh and a 2D flat mesh;

FIG. 5 is a diagram showing a notation for angles in a mesh;

FIG. 6 is a view of a surface of a 3D flow image at an identified interface between the placenta and the uterus of a pregnant woman;

FIG. 7 is a view of a 2D flow image corresponding to the surface of FIG. 6 mapped into two dimensions;

FIG. 8 is a view of three 2D flow images derived from the same image data but using different mappings; and

FIGS. 9 and 10 are views of a stack of 2D flow images at different distances acquired from the same basal plate at different times of the pregnancy.

Other features of the present embodiments will be apparent from the accompanying drawings and from the detailed description that follows.

### DETAILED DESCRIPTION OF THE INVENTION

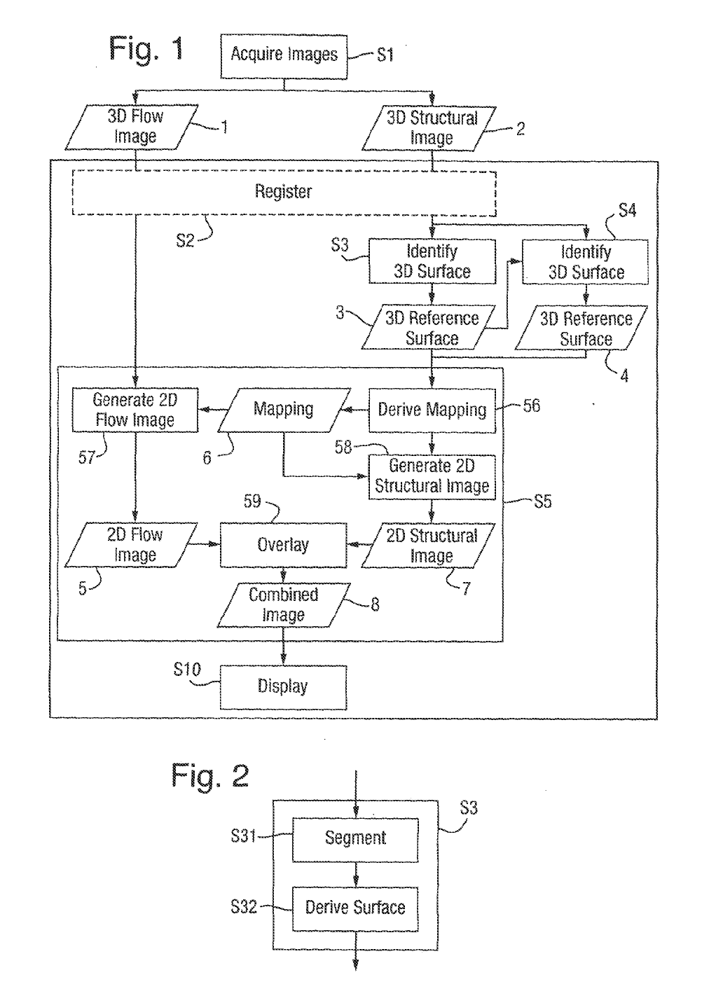

FIG. 1 shows a method of acquiring and transforming a three-dimensional (3D) flow image 1, in which a three dimensional structural image 2 is also acquired and used.

In step 1, a subject is imaged to acquire the 3D flow image 1 and the 3D structural image 2, each comprising a set of values for respective voxels (3D pixels) in a field of view. The 3D flow image 1 represents flow within the subject. The 3D structural image 2 has a common field of view with the 3D flow image 1 and represents structure within the same subject.

Any type of imaging technique that acquires the 3D flow image 1 and the 3D structural image 2 may be used. Step S1 may be performed using known techniques with appropriate imaging apparatus.

One type of imaging technique that may be applied to both the 3D flow image 1 and the 3D structural image 2 is ultrasonography. In this case, the 3D flow image 1 is an ultrasound intensity image, in which the image data represents the intensity of the measured ultrasound signal scattered by the subject. Furthermore, the 3D structural image 2 is an ultrasound Doppler image, in which the image data represents the Doppler components of the measured ultrasound signal, for example a power Doppler signal representing an integral of the Doppler components or a colour Doppler signal representing a mean frequency of the Doppler components. This has the advantage that both the 3D flow image 1 and the 3D structural image 2 may be acquired by the same ultrasonography apparatus.

However, either or both of the 3D flow image 1 and the 3D structural image 2 may be acquired using imaging techniques other than ultrasonography. For example, the 3D flow image 1 may be acquired using BOLD imaging or other types of fMRI and the 3D structural image 2 may be acquired using MRI or CT. The imaging techniques for the 3D flow image 1 and the 3D structural image 2 may be applied in any combination.

The 3D flow image 1 and the 3D structural image 2 acquired in step S1 are processed in steps S2 to S10 which are conveniently performed by a computer program executed on a computer system 10 illustrated schematically by a dotted line in FIG. 1. The computer system 10 may be any type of computer system but is typically a conventional personal computer. The computer program may be written in any suitable programming language. The computer program may be stored on a computer-readable storage medium, which may be of any type, for example: a recording medium which is insertable into a drive of the computing system and which may store information magnetically, optically or opto-magnetically; a fixed recording medium of the computer system such as a hard drive; or a computer memory.

As an alternative, the computer system 10 could be a system dedicated to the present analysis, for example associated with a system used to acquire the 3D flow image 1 and/or the 3D structural image 2 in step S1. In this case the computer system 10 could be optimised for performing the analysis, for example by running various processes in parallel.

The 3D flow image 1 and the 3D structural image 2 input into the computer system 10 may already be registered with one another due to their acquisition in step S1. For example, if both the 3D flow image 1 and the 3D structural image 2 are acquired by the same ultrasonography apparatus then they will be intrinsically registered, or if the 3D flow image 1 and the 3D structural image 2 are acquired by different apparatuses then they may registered by a physical technique. However, in the event that the 3D flow image 1 and the 3D structural image 2 are not registered, then optional step S2 is performed to register them with each other by processing of the 3D flow image 1 and the 3D structural image 2 themselves. This may be done by any of the large number of known registration techniques which exist, for example as disclosed in, inter alia, Reference 3 or Reference 4.

In step S3, the 3D structural image 2 is analysed to identify therewithin a first 3D reference surface 3 that represents the location of a surface of the structure represented by the 3D structural image 2. In general, any surface of interest in the represented structure may be identified. The 3D reference surface 3 is represented by a mesh comprising vertices interconnected by edges, for example a triangular mesh in which three edges are connected to each vertex.

In one example, the 3D reference surface 3 represents the location of a boundary of a part within the structure of the subject or an interface between two parts within the structure. One possible method of identifying such a boundary or interface as the 3D reference surface 3 is shown in FIG. 2 and performed as follows.

In step S31, the voxel volumes of one or more structures of the subject are segmented from the 3D structural image 2. A wide range of segmentation techniques are known and any suitable segmentation technique may be applied in step S31. For example, a segmentation that has been applied successfully to identify the interface between a placenta and a uterus in an ultrasound power Doppler image is the random walk algorithm disclosed in Reference 5. This algorithm involves seeding of the algorithm by the user inputting data identifying examples of the parts of the structure, which the algorithm uses to perform the segmentation.

In step S32, the 3D reference surface 3 is derived. The 3D reference surface 3 may be derived as the boundary of the segmented voxel volume of a structure, or an interface between the segmented voxel volumes of two structures, in particular by generating iso-surfaces from the segmented voxel volumes, for example using the surface normals.

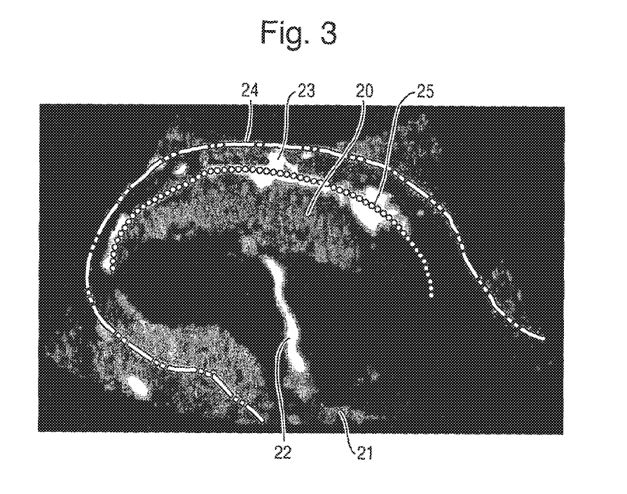

In an example where the subject is the placenta and uterus of a pregnant woman, the 3D reference surface 3 may be derived as a portion of the boundary of the segmented volume of the placenta that forms the interface with the uterus (basal plate), as will now be described with reference to FIG. 3 which is a 2D slice of the 3D structural image 2 which in this example is an ultrasound intensity image. FIG. 3 illustrates the placenta 20 connected to the fetus 21 by the umbilical cord 22, and the uterus 23 inside the uterine wall 24, with the interface (basal plate) 25 therebetween. The surface of the segmented volume of the placenta 20 encompass the whole placenta 20 and a portion that forms an interface 25 with the uterus 25 is extracted as follows. A threshold is chosen empirically for the component of the surface normal to which the interface 25 and used to extracted the interface 25.

This extraction operation can lead to the triangular mesh of the 3D reference surface 3 being corrupted that will result in failure of the parameterisation described below. To overcome this problem, all vertexes and edges are checked to determine that they are appropriately connected. Triangles are removed that are: non-manifold; have any vertex that is not shared by another triangle (i.e. a corner vertex); or have more than one edge that is not shared by another triangle in the mesh (i.e. a hanging triangle). This process is repeated until no triangles that have one or more of these characteristics in the mesh are present. Optionally, a Delaunay triangulation is performed and the Euler characteristic is used to check that the surface is well-conditioned for the parameterisation.

As an alternative to the method shown in FIG. 2, step S3 could apply a segmentation technique that directly derives a surface as the 3D reference surface 3.

In step S4, the 3D structural image 2 is further analysed to identify therewithin a plurality of offset 3D reference surfaces 4 that represent locations at respective distances from location represented by the first 3D reference surface 3, both inwardly and outwardly. The distances of the offset 3D reference surfaces 4 are set at intervals that are greater than the largest voxel dimension, in order to avoid interpolation of data.

Any suitable techniques may be applied in step S4, for example using a signed distance transform, such as that disclosed in Reference 6, although other distance measures could equally be applied, for example minimum distance or Euclidean distance.

Where step S3 uses the method shown in FIG. 2, the offset 3D reference surfaces 4 may be identified in step S4 from the boundary or interface of the segmented voxel volume. In the example given above where the first 3D reference surface 3 is derived as a portion of the boundary of the segmented volume of the placenta 20, then the offset 3D reference surfaces 4 are each extracted as a portion of a surface derived from the entire boundary of the segmented volume of the placenta 20, using the same extraction method as disclosed above for the 3D reference surface 3.

In step S5, the 3D flow image 1 is transformed to generate a 2D flow image 5 in respect of each of the first 3D reference surface 3 and the offset 3D reference surfaces 4. Step S5 comprises steps S6 to S9 that are performed independently in respect of each of the 3D reference surfaces 3 and 4, as follows.

In step S6, the respective 3D reference surface 3 or 4 is analysed to derive a mapping 6 that maps the 3D reference surface 3 or 4 into a 2D plane, that in general can be of any shape but is typically circular. This step derives such a mapping 6 without necessarily deriving a 2D image. The mapping 6 may be derived by performing a mesh parameterisation of the 3D reference surface 3. Such mesh paramerisation may be performed using a variety of different methods, for example the methods disclosed in Reference 7 which provides an extensive review dividing the methods into groups based on: whether the planar boundary is free or fixed; numerical complexity; and bijectivity of the mapping.

There will now be described an example of step S6 using linear parameterisation that has been applied to a study of the placenta and uterus of a pregnant woman, wherein the 3D structural image 2 was an ultrasound intensity image. This example uses an implementation of the type disclosed in Reference 8 using linear parameterisation with fixed boundaries. This has been implemented using the open-source package ITK disclosed in Reference 9. Display of the results has been performed using The Visualization Toolkit (VTK) which is an open-source, freely available software system for 3D computer graphics, image processing and visualization. Compared to more complex algorithms which can be applied on more intricate structures, this method has an advantage of speed that is important in a clinical setting.

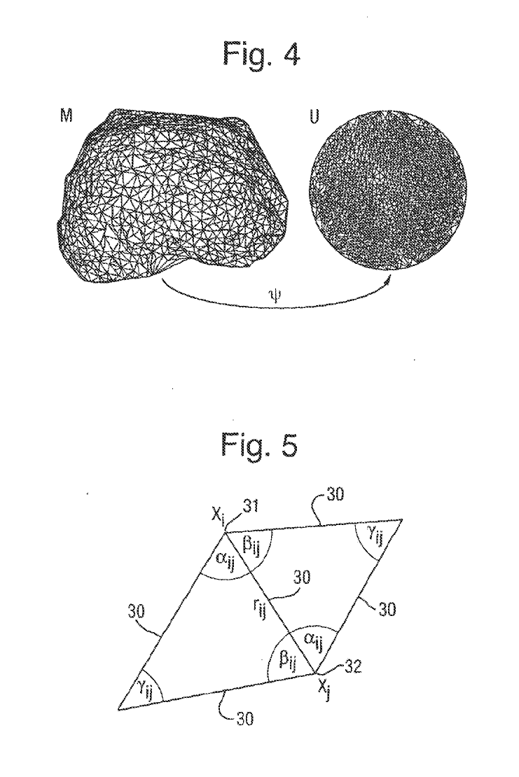

As illustrated in FIG. 4, the parameterisation derives a piecewise linear mapping between a 3D mesh M that represents the 3D reference surface 3 or 4 and an isomorphic flat mesh U that represents the two-dimensional plane, in the example of FIG. 4 a disc. If the 3D mesh M is defined as xᵢ=(xᵢ, yᵢ, zᵢ) for each vertex i, then the linear mapping Ψ is defined as a mapping ψᵢ for each vertex i to the flat mesh U defined by uᵢ=(uᵢ, vᵢ) for each vertex i.

This parameterization is achieved by fixing the boundary vertices of the 3D reference surface 3 to the boundary of a 2D plane, in this example a disc, and then performing an energy minimization of the non-boundary vertices in order to flatten them appropriately onto the disc.

Reference 8 describes such a parameterisation as akin to a spring mass model where each edge a spring and each vertex a mass. Having fixed the boundary, the interior vertices will relax to the minimum of the spring energy.

This is performed by solving the following sparse linear system:

A·U=Ū (1)

where:

U={(uᵢ), i=1, . . . , n}={(uᵢ, vᵢ), i=1, . . . , n} is a 2×n matrix of the unknown (inner) vertices;

Ū={(ūᵢ), i=1, . . . , n}={(ūᵢ, v̅ᵢ), i=1, . . . , n} is a 2×n matrix of the fixed boundary vertices with coefficients calculated according to:

$$( {\overline{u}}_{i} {\overline{v}}_{i} ) = {\sum }_{j ∈ {N}_{i} , j ∈ B} - ( \frac{{D}_{ij}}{{\sum }_{k ∈ {N}_{i}} {D}_{ik}} ( {u}_{j} , {v}_{j} ) ) \qquad ( 3 )$$

where N is the group of neighbouring vertices for a particular vertex and B is a the group of boundary vertices; and

A is a n×n sparse square matrix having elements:

$${A}_{ij} = \{ \begin{matrix}1 & if i = j , \\ - {D}_{ij} / {\sum }_{k ∈ {N}_{i}} {D}_{ik} & if j ∈ {N}_{i} , \\ 0 & else\end{matrix} \qquad ( 2 )$$

The values Dᵢⱼ are a barycentric weightings that represents the interaction between the vertices, corresponding to the spring constants if the parameterisation is considered as akin to a spring mass model. Barycentric weightings Dᵢⱼ of any suitable form may be applied. The literature proposes many different barycentric weightings Dᵢⱼ, that perform differently but any of which may in general be applied. The choice of the barycentric weightings Dᵢⱼ has bearing on how the vertices interact and hence how the mapping 6 flattens the 3D reference surface 3. Some alternative examples of suitable barycentric weightings Dᵢⱼ are defined in the following equations:

$$\begin{matrix}{D}_{ij} = 1 & ( 4 ) \\ {D}_{ij} = cot {γ}_{ij} + cot {γ}_{ji} & ( 5 ) \\ {D}_{ij} = \frac{cot {β}_{ij} + cot {α}_{ji}}{{‖ {x}_{i} - {x}_{j} ‖}^{2}} & ( 6 )\end{matrix}$$

wherein the notation of the parameters are shown in FIG. 5 which illustrates the angles between edges 30 connecting two vertices 31 labelled Xᵢ and Xⱼ.

The barycentric weightings Dᵢⱼ defined by Equation 4 are designed for speed and to be able to map between the flat disc and original surface back and forth in an bijective manner. The barycentric weightings Dᵢⱼ defined by Equations 5 and 6 preserve conformal (angles) or authalic (area) properties of the original mesh, respectively, at a cost of increased computation. The barycentric weightings Dᵢⱼ may be chosen to preserve conformal properties if it is desired to maintain the relationship between structures in the 2D flow image 5, or the barycentric weightings Dᵢⱼ may be chosen to preserve authalic properties if it is desired to consistently quantify flow in different parts of the 2D flow image 5.

This method could be changed by usage of other barycentric weightings Dᵢⱼ, faster sparse linear system solvers and automatic segmentation of the basal plate area, for example to bring more stability to the method.

In step S7, the 2D flow image 5 is generated from the 3D flow image 1 using the mapping. In particular, a surface of the 3D flow image 1 at the location represented by the 3D reference surface 3 or 4 is extracted from the 3D flow image 1 and the mapping 6 is applied to map that surface into the 2D flow image 5.

The 2D flow images 5 generated in respect of each 3D reference image 3 or 4 are displayed as follows.

In step S8, a 2D structural image 7 is generated from the 3D structural image 2 using the mapping 6. In particular, a surface of the 3D structural image 2 at the location represented by the 3D reference surface 3 or 4 is extracted from the 3D structural image 2 and the mapping 6 is applied to map that surface into the 2D structural image 7.

Then, in step S9, the 2D flow image 5 is overlaid on the 2D structural image 7 to produce a combined image 8. Any suitable technique may be applied for this. In one example, the 2D flow image 5 may obscure the 2D structural image 7, which is suitable if the 2D flow image 5 has significant areas of null values. In another example, the 2D flow image 5 may be made translucent so that the 2D structural image 7 is visible therethrough. In the combined image 8, the 2D flow image 5 and the 2D structural image 7 may be represented differently to allow them to be distinguished, for example representing the 2D flow image 5 in colour and the 2D structural image 7 in black-and-white.

The combined images 9 are useful because they allow display of both the 2D flow image 5 and the 2D structural image 7 together, thereby providing a 2D morphological and functional map of the subject under investigation.

In step S10, each combined image 8, i.e. in respect of each 3D reference surface 3 or 4, is displayed. Typically the combined images 9 are arranging in order of the position of the 3D reference surface 3 and 4 to make clear their relationship as a stack of surfaces.

The 2D flow images 5 may have equal areas, but desirably the areas of the 2D flow images 5 (and the areas of the corresponding 2D structural images 7) are scaled in proportion to the areas of 3D reference surface 3 and 4 from which they are derived. This facilitates understanding of the stack of 2D flow images 5 by consistently representing area.

The levels of the 2D flow images 5 may be normalised to provide a consistent representation, for example between 3D flow images 1 acquired using a different modality (e.g. different imaging apparatuses or acquisition settings), between different subjects and/or between different time periods. Such normalisation provides standardisation that may be useful, particularly in a clinical setting where it allows comparison between different patients and over time for the same patient. For example patients may have different body mass indices or other signal attenuating factors that mean that comparing like values is not necessarily an indication of equal perfusion in the interface, but the normalisation may provide a degree of compensation for this.

Such normalisation may be performed relative to a reference level derived from 3D flow image 1. In one example, the reference level may be the maximum flow in the entire 3D flow image 1 or in one of the 2D flow images 5. In another example, by taking the plexus of vasculature on the maternal side of the stacks of surfaces, a normalisation factor can be created on the basis of this area of the placenta which can be considered a place where maximal flow occurs. In particular, the levels can be normalised relative to the intensity in this area, i.e. considering that intensity as 100% flow.

The method described above has been performed on a subject that is the placenta and uterus of a pregnant woman, using ultrasonography to acquire the 3D flow image 1 as a an ultrasound power Doppler image and the 3D structural image 2 as an ultrasound intensity image, as follows. The first 3D reference surface 3 was derived as a portion of the boundary of the segmented volume of the placenta that forms the interface with the uterus.

With ethical approval, women were recruited with a singleton pregnancy and a BMI of no more than 35. Multiple 3D ultrasound scans were acquired using a GE Voluson E8 (GE Healthcare, Milwaukee, Wis., USA.) biweekly from 12 to 18 weeks of gestation as part of a larger study. All ultrasound settings were kept constant with exception of the power Doppler gain, which was determined by user adjustment from a high level where signal to noise ratio was very low and gradually lowering it to a point where the user perceived Doppler artefact to be minimised.

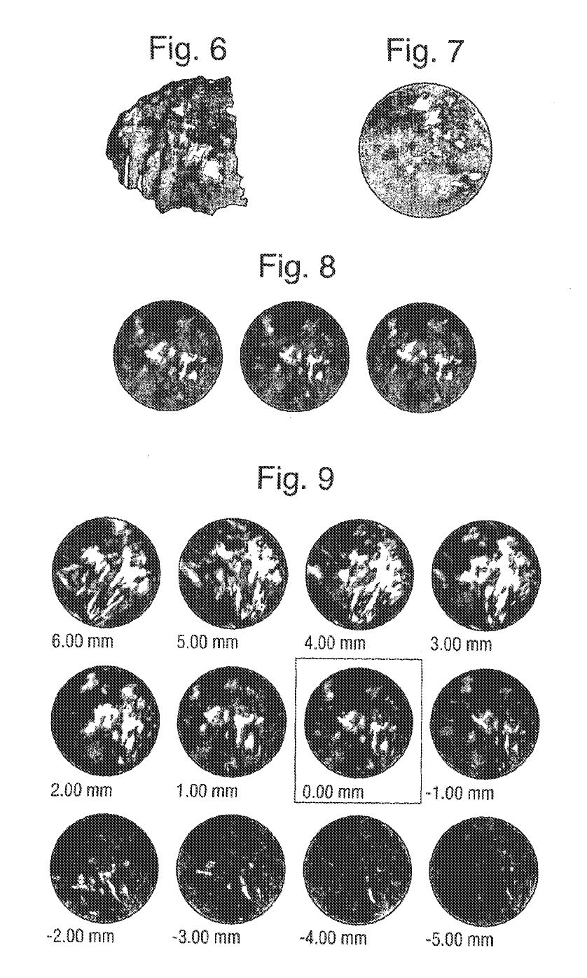

Some examples of images are shown in FIGS. 6 to 10. In each case, in the original image, image information extracted from the 3D structural image 2 is in black-and-white, and image information extracted from the 3D flow image 1 is in colour that is visible as the brighter portions of FIGS. 6 to 10.

FIG. 6 shows an example of surface of the 3D flow image 1 at the location represented by the first 3D reference surface 3 overlaid on the 3D structural image 2 at the same location. It is difficult to understand and quantify the flow represented by the data of this surface of the three-dimensional flow image in a meaningful way because it has an irregular three-dimensional shape. Furthermore, visual investigation is difficult, because regardless of the view orientation parts of the surface are obscured due to the three-dimensional shape of the surface.

FIG. 7 shows an example of the combined image 8 that is mapped from the surface shown in FIG. 6. It is much easier to understand and quantify the represented flow because the irregularity has been removed by the mapping into two dimensions. Furthermore, visual investigation is made easier, because there is no occlusion. The gain level and other settings of the ultrasonography may be changed to vary the appearance of 2D flow images 5.

FIG. 8 shows an example of three 2D flow images 5 that have been generated from the same image data of a basal plate at 12+5 weeks gestation, but in which parameterisation is performed using the barycentric weightings Dᵢⱼ of Equations (4), (5) and (6) respectively. As can be seen, the variation of the barycentric weightings Dᵢⱼ creates visual differences in the resultant. Visually there is a difference in each of 2D flow images 5, and the barycentric weightings Dᵢⱼ may be chosen having regard to the information of clinical interest. That being said, any of the choice of barycentric weightings Dᵢⱼ provide useful information having the advantages discussed above.

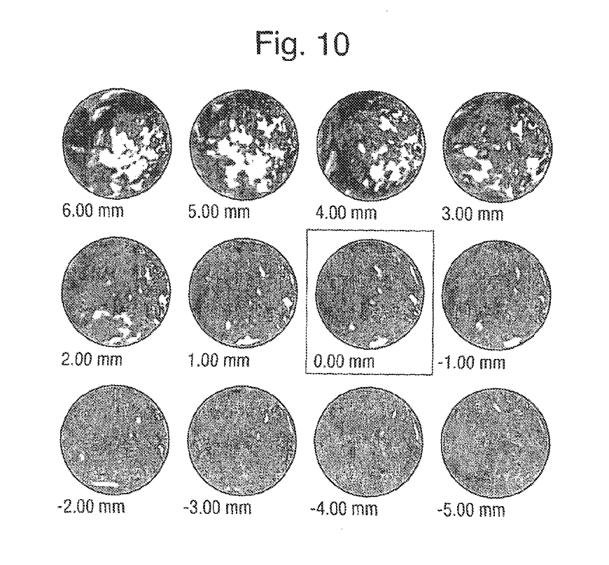

FIGS. 9 and 10 each show a stack of combined images 9 in respect of a stack of 3D reference surfaces 3 and 4 generated from image data acquired from the same pregnant woman at 12+5 weeks gestation and 14+1 weeks gestation, respectively. The distances between the 3D reference surfaces 3 and 4 was set at a uniform interval, as indicated by the annotations, a positive distance being on the maternal (uterine) side of the basal plate and a positive distance being on the fetal (plancental) side of the basal plate. The parameterisation performed used the barycentric weightings Dᵢⱼ of Equation (5) in each case.

It can be seen from each of FIGS. 9 and 10 that the stack of combined images 9 allow the vasculature on both the maternal and fetal side of the basal plate to be visualised and analysed in an easy manner, this being achieved despite the irregular shape of the basal plate. A similar pattern of large plexus of vessels is seen in adjacent combined images 9 in each stack showing the vasculature extending through the placenta and uterus. Furthermore, the amount of vasculature is greatest at the furthest level away from the interface on the maternal side, with the intensity and occurrence of flow reducing towards the basal plate and into the placenta. This pattern of vascularisation tallies with the anatomy of the uterine circulation understood to occur from histopathological and anatomical studies that shows large bore vessels reducing down into a network of small bore spiral arterioles that supply the placenta, thereby providing the possibility of allowing the vasculature to be studied and quantified to obtain information of clinical significance. This makes it possible to view differences in the vasculature on both sides of the basal plate which might correlate with a change in placental function, potentially indicating poor trophoblastic remodelling of the spiral arterioles which is one of causes behind pre-eclampsia and intrauterine growth restriction, the biggest pathologies in pregnancy.

As the stack of combined images 9 correspond to surfaces at, and predetermined distances from, the placental basal plate, the surface supplied by maternal blood only, it is believed that the stack of combined images 9 will reflect the haemodynamics of the flow within the utero-placental unit, for example based on the observations in Reference 10. Poor remodelling leads to differences in flow throughout the vasculature so investigating these surfaces may glean further knowledge into blood flow both over gestation and in the normal and pathological case.

The method may be applied to other parts of a human body to provide similar benefits in visualising flow with the human body. Similar boundaries can also occur in other biological areas such as in tumours or other organs, for example the liver, where blood flows are currently observable using ultrasound. The 3D reference surface may represent the location of an interface between two parts of the structure of the subject or more generally to any surface of the structure that may be detected in the 3D structural image. Similarly, the method may in general be used to investigate any flow detectable with an imaging technique.

The method may equally be applied to other biological subjects, that might include for instance, layers of tissue or fibres, but also to subjects that are not biological.

Although embodiments of the invention have been described in considerable details with reference to certain preferred versions thereof, other embodiments are possible. Therefore, the spirit and scope of the appended claims should not be limited to the descriptions of the embodiments above.

1. A method of transforming a three-dimensional flow image that represents flow within a subject, wherein the method additionally uses a three-dimensional structural image that has a common field of view with the three-dimensional flow image and that represents structure within the subject, and the method comprises:
identifying from the three-dimensional structural image a three-dimensional reference surface that represents the location of a surface of the structure represented by the three-dimensional structural image;
deriving a mapping that maps the three-dimensional reference surface into a two-dimensional plane; and
generating a two-dimensional flow image by applying the mapping to map a surface of the three-dimensional flow image at the location represented by the three-dimensional reference surface into the two-dimensional flow image.

2. A method according to claim 1, wherein the method further comprises:
identifying from the three-dimensional structural image offset three-dimensional reference surfaces that represent locations at respective distances from the location represented by the first mentioned three-dimensional reference surface; and
performing said steps of deriving a mapping and generating a two-dimensional flow image in respect of each of the offset three-dimensional reference surfaces, as well as the first mentioned three-dimensional reference surface.

3. A method according to claim 2, wherein the two-dimensional flow images have areas that are scaled in proportion to the areas of the respective three-dimensional reference surfaces.

4. A method according to claim 1, wherein the three-dimensional flow image is an ultrasound Doppler image.

5. A method according to claim 4, wherein the three-dimensional structural image is an ultrasound intensity image.

6. A method according to claim 1, wherein said surface of the structure represented by the represented by the three-dimensional structural image is a boundary of a part of the structure or an interface between two parts of the structure.

7. A method according to claim 1, wherein the subject is a biological subject.

8. A method according to claim 7, wherein the subject is part of a human body.

9. A method according to claim 8, wherein subject is a placenta and uterus of a pregnant woman, and the three-dimensional reference surface is an interface between the placenta and the uterus.

10. A method according to claim 1, further comprising displaying the or each two-dimensional flow image.

11. A method according to claim 1, wherein further comprising, in respect of the or each three-dimensional reference surface:
generating a two-dimensional structural image by applying the mapping to map a surface of the three-dimensional structural image at the location represented by the three-dimensional reference surface into the two-dimensional structural image
overlaying the two-dimensional flow image on the two-dimensional structural image.

12. A method according to claim 11, further comprising displaying the or each two-dimensional flow image overlaid on the respective two-dimensional structural image.

13. A method according to claim 1, wherein said step of identifying the first mentioned three-dimensional reference surface comprises:
segmenting one or more volumes within the three-dimensional structural image; and
identifying a surface of a segmented volume or a boundary between segmented volumes as said first mentioned three-dimensional reference surface.

14. A method according to claim 1, wherein the or each three-dimensional reference surface is represented by a mesh comprising vertices interconnected by edges.

15. A method according to claim 1, wherein said step of deriving a mapping comprises deriving a mapping by performing mesh parameterisation.

16. A method according to claim 1, wherein the levels of the or each two-dimensional flow image are normalised relative to a reference level derived from three-dimensional flow image.

17. A method according to claim 1, in combination with a step of acquiring the three-dimensional flow image and the three-dimensional structural image.

18-19. (canceled)

20. A computer-readable memory storing a plurality of instructions for controlling a computer system to transform a three-dimensional flow image that represents flow within a subject using a three-dimensional structural image that has a common field of view with the three-dimensional flow image and that represents structure within the subject, the plurality of instructions comprising:
instructions that cause the computer system to identify from the three-dimensional structural image a three-dimensional reference surface that represents the location of a surface of the structure represented by the three-dimensional structural image;
instructions that cause the computer system to derive a mapping that maps the three-dimensional reference surface into a two-dimensional plane; and
instructions that cause the computer system to generate a two-dimensional flow image by applying the mapping to map a surface of the three-dimensional flow image at the locations represented by the three-dimensional reference surface into the two-dimensional flow image.

21. A computer-readable memory according to claim 20, wherein the memory stores information magnetically, optically or opto-magnetically.
